(19) United States
(12) Patent Application Publication
(10) Pub. No.: US 2009/0195741 A1
(43) Pub. Date: Aug. 6, 2009

(54) LIQUID CRYSTAL DISPLAY AND METHOD FOR MANUFACTURING LIQUID CRYSTAL DISPLAY

(76) Inventors: Yoshihito Hara, Mie (JP); Tetsuo Kikuchi, Mie (JP); Hideki Kitagawa, Mie (JP); Hajime Imai, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/306,959

(22) PCT Filed: Jun. 8, 2007
(86) PCT No.: PCT/JP2007/061632

§ 371 Date: Dec. 30, 2008

(30) Foreign Application Priority Data
Jun. 30, 2006 (JP) 2006-182264

(51) Int. Cl. G02F 1/1335; G02F 1/13

(52) U.S. Cl. 349/114; 349/113; 349/187

(57) ABSTRACT

An objective of the present invention is to provide a transflective type liquid crystal display device and a reflection type liquid crystal display device having a high image quality at low cost. A liquid crystal display device according to the present invention is a liquid crystal display device having a reflection section for reflecting incident light toward a display surface. The reflection section includes an insulating layer; a semiconductor layer formed above the insulating layer; and a reflective layer formed above the semiconductor layer. On a surface of the reflective layer, a first recess and a second recess which is located inside the first recess are formed. The reflection section includes a first region and a second region which differ in a total thickness of a thickness of the insulating layer and a thickness of the semiconductor layer. The first recess and the second recess are formed in accordance with a cross-sectional shape of at least one of the insulating layer and the semiconductor layer.

### TECHNICAL FIELD

The present invention relates to a reflection-type or transflective-type liquid crystal display device which can perform display by utilizing reflected light.

### BACKGROUND ART

Liquid crystal display devices (LCDs) include the transmission-type LCD which utilizes backlight from behind the display panel as a light source for displaying, the reflection-type LCD which utilizes reflected light of external light, and the transflective-type LCD (reflection/transmission-type LCD) which utilizes both reflected light and backlight as light sources. The reflection-type LCD and the transflective-type LCD are characterized in that they have smaller power consumptions than that of the transmission-type LCD, and their displayed images are easy to see in a bright place. The transflective-type LCD is characterized in that their displayed images are easier to see than that of the reflection-type LCD, even in a dark place.

FIG. 12 is a cross-sectional view showing the construction of an active matrix substrate 100 of a conventional reflection-type LCD (e.g., Patent Document 1).

As shown in FIG. 12, the active matrix substrate 100 includes an insulative substrate 101, as well as a gate layer 102, a gate insulating layer 104, a semiconductor layer 106, a metal layer 108, and a reflective layer 110, which are stacked on the insulative substrate 101. After being stacked on the insulative substrate 101, the gate layer 102, the gate insulating layer 104, the semiconductor layer 106, and the metal layer 108 are subjected to etching by using one mask, thus being formed so as to have an island-like multilayer structure. Thereafter, the reflective layer 110 is formed on this multilayer structure, whereby a reflection surface 112 having ruggednesses is formed. Although not shown, transparent electrodes, a liquid crystal panel, a color filter substrate (CF substrate), and the like are formed above the active matrix substrate 100.

[Patent Document 1] Japanese Laid-Open Patent Publication No. 9-54318

### DISCLOSUREE OF INVENTION

### Problems to be Solved by the Invention

In the aforementioned active matrix substrate 100, portions of the reflective layer 110 are formed so as to reach the insulative substrate 101 in portions where the gate layer 102 and the like are not formed (i.e., portions between the islands, hereinafter referred to as “gap portion”). Therefore, in the gap portions, the surface of the reflection surface 112 is recessed in the direction of the insulative substrate 101, thus forming deep dents (or recesses).

In a reflection-type or transflective-type liquid crystal display device, in order to perform bright display by utilizing reflected light, it is necessary to allow light entering from various directions to be reflected by a reflection surface more uniformly and efficiently over the entire display surface. For this purpose, it is better if the reflection surface is not completely planar but has moderate ruggednesses.

However, the reflection surface 112 of the aforementioned active matrix substrate 100 has deep dents. Therefore, light is unlikely to reach the reflection surface located on the bottoms of the dents, and even if at all light reaches there, the reflected light thereof is unlikely to be reflected toward the liquid crystal panel. Thus, the aforementioned conventional liquid crystal display device has a problem in that the reflected light is not effectively used for displaying. Furthermore, there is also a problem in that, since many portions of the reflection surface 110 have a large angle relative to the display surface of the liquid crystal display device, the reflected light from those portions is not effectively utilized for displaying.

FIG. 13 is a diagram showing a relationship between the tilt of the reflection surface 112 and reflected light. FIG. 13(a) shows a relationship between an incident angle α and an outgoing angle β when light enters a medium b having a refractive index Nb from a medium a having a refractive index Na. In this case, according to Snell's Law, the following relationship holds true.

Na×sin αNb×sin β

FIG. 13(b) is a diagram showing a relationship between incident light and reflected light when incident light perpendicularly entering the display surface of an LCD is reflected from a reflection surface which is tilted by θ with respect to the display surface (or the substrate). As shown in the figure, the incident light perpendicularly entering the display surface is reflected from the reflection surface which is tilted by angle θ with respect to the display surface, and goes out in a direction of an outgoing angle φ.

Results of calculating the outgoing angle φ according to Snell's Law with respect to each angle θ of the reflection surface are shown in Table 1.

TABLE 1

| θ | φ | 90 − φ |
|---|---|---|
| 0 | 0 | 90 |
| 2 | 6.006121 | 83.99388 |
| 4 | 12.04967 | 77.95033 |
| 6 | 18.17181 | 71.82819 |
| 8 | 24.42212 | 65.57788 |
| 10 | 30.86588 | 59.13412 |
| 12 | 37.59709 | 52.40291 |
| 14 | 44.76554 | 45.23446 |
| 16 | 52.64382 | 37.35618 |
| 18 | 61.84543 | 28.15457 |
| 20 | 74.61857 | 15.38143 |
| 20.5 | 79.76542 | 10.23458 |
| 20.6 | 81.12757 | 8.872432 |
| 20.7 | 82.73315 | 7.266848 |
| 20.8 | 84.80311 | 5.19888 |
| 20.9 | 88.85036 | 1.149637 |
| 20.905 | 89.79914 | 0.200856 |

The values in this Table are calculated by assuming that air has a refractive index of 1.0 and the glass substrate and the liquid crystal layer have a refractive index of 1.5. As shown in Table 1, when the angle θ of the reflection surface exceeds 20 degrees, the outgoing angle φ becomes very large (i.e., 90-φ becomes very small), so that most of the outgoing light does not reach the user.

Therefore, even if ruggednesses are provided on the reflection surface of the reflective layer, it is necessary to ensure that the angle θ is 20 degrees or less in greater portions of the reflection surface in order to effectively use the reflected light.

Since the reflection surface 112 of the aforementioned active matrix substrate 100 has many portions having an angle which is greater than 20 degrees with respect to the display surface, reflected light is not very effectively used for displaying. In order to solve this problem, it might be possible to form an insulating layer under the reflective layer 110 so as to cover the metal layer 108, thereby smoothing the reflection surface. However, in this case, a step of forming an insulating layer, a step of forming contact holes for connecting the reflective layer 110 to the drains of TFTs in the insulating layer, and the like are needed, thus resulting in a problem of an increase in the material and the number of steps.

The present invention has been made in view of the above problems, and an objective thereof is to provide a low-cost reflection-type or transflective-type liquid crystal display device having a high image quality.

### Means for Solving the Problems

A liquid crystal display device is a liquid crystal display device comprising a reflection region for reflecting incident light toward a display surface, wherein, the reflection region includes an insulating layer, a semiconductor layer formed above the insulating layer, and a reflective layer formed above the semiconductor layer; a first recess and a second recess which is located inside the first recess are formed on a surface of the reflective layer; and the reflection region includes a first region and a second region which differ in a total thickness of a thickness of the insulating layer and a thickness of the semiconductor layer, and the first recess and the second recess are formed in accordance with a cross-sectional shape of at least one of the insulating layer and the semiconductor layer.

In one embodiment, the first region includes a flat region where the total thickness of the thickness of the insulating layer and the thickness of the semiconductor layer is substantially constant.

In one embodiment, the thickness of the semiconductor layer in the first region is thicker than the thickness of the semiconductor layer in the second region.

In one embodiment, the thickness of the insulating layer in the first region is substantially equal to the thickness of the insulating layer in the second region.

In one embodiment, the thickness of the insulating layer in the first region is thicker than the thickness of the insulating layer in the second region.

In one embodiment, a first slope is formed in the first recess and a second slope is formed inside the second recess.

In one embodiment, each of the first slope and the second slope has a face having a tilting angle of 20 degrees or less with respect to the display surface.

In one embodiment, each of the first slope and the second slope has an average tilting angle of 20 degrees or less with respect to the display surface.

In one embodiment, a flat surface which is substantially parallel to the display surface is formed between the first slope and the second slope, and the first slope, the flat surface, and the second slope have an average tilting angle of 20 degrees or less with respect to the display surface.

In one embodiment, the first recess and the second recess are each formed in plurality in the reflection region.

A production method for a liquid crystal display device according to the present invention is a production method for a liquid crystal display device having a reflection region for reflecting incident light toward a display surface, comprising: a step of forming an insulating layer; a step of forming a semiconductor layer above the insulating layer; a step of forming a first region and a second region which differ in a total thickness of the thickness of the Insulating layer and the thickness of the semiconductor layer; and a step of forming a reflective layer above the semiconductor layer, wherein, in accordance with a cross-sectional shape of at least one of the insulating layer and the semiconductor layer, a first recess and a second recess which is located inside the first recess are formed on a surface of the reflective layer.

In one embodiment, in the first region, a flat region where the total thickness of the thickness of the insulating layer and the thickness of the semiconductor layer is substantially constant is formed.

In one embodiment, the step of forming the first region and the second region comprises a step of forming two regions of respectively different thicknesses in the semiconductor layer in the reflection region.

In one embodiment, the step of forming the first region and the second region comprises a step of forming two regions of respectively different thicknesses in the insulating layer in the reflection region.

In one embodiment, the step of forming the first region and the second region comprises a step of forming an aperture in the semiconductor layer.

In one embodiment, the step of forming the first region and the second region comprises a step of forming a first slope on the semiconductor layer in the first region and a step of forming a second slope on the semiconductor layer or the insulating layer in the second region.

In one embodiment, the first region and the second region are formed by half tone exposure.

In one embodiment, the first region and the second region are formed by two-step exposure.

In one embodiment, the liquid crystal display device includes a semiconductor device; a semiconductor section of the semiconductor device is formed in the step of forming the semiconductor layer; and a source electrode and a drain electrode of the semiconductor device are formed in the step of forming the metal layer.

### EFFECTS OF THE INVENTION

According to the present invention, a large number of recesses, protrusions, level differences, and corner portions can be formed on the surface of a reflective layer in accordance with the level differences or cross-sectional shape of a semiconductor layer or an insulating layer. Therefore, a liquid crystal display device having a high reflection efficiency can be provided.

Moreover, since at least the semiconductor layer and the metal layer in the reflection region are concurrently formed from the same material as that of a layer composing transistors, reflection regions having excellent reflection characteristics can be obtained at low cost, without increasing the production steps.

Therefore, according to the present invention, transflective type and reflection type liquid crystal display devices having a high image quality and high reflection characteristics in the reflection regions can be provided with a good production efficiency and at low cost.

### BRIEF DESCRIPTION OF DRAWINGS

FIG. 1 A diagram schematically showing a cross-sectional shape of the liquid crystal display device according to Embodiment 1 of the present invention.

FIG. 2 A diagram specifically showing the construction of pixel regions and reflection sections of Embodiment 1, where (a) is a plan view showing a portion of the pixel regions as seen from above the display surface, and (b) is a and (b) shows the construction of a reflection section plan view schematically showing the construction of a reflection section of the liquid crystal display device.

FIG. 3 A cross-sectional view showing the construction of a reflection section and a TFT section of Embodiment 1, where (a) shows the construction of a reflection section, and (b) shows the construction of a TFT section.

FIG. 4 A schematic diagram for comparison in construction between a reflection section of Embodiment 1 and a reflection section of a conventional liquid crystal display device, where: (a) shows a cross section of the reflection section; (b) shows a cross section of the reflection section of the conventional liquid crystal display device; and (c) shows surface angles at a corner portion of the reflection section.

FIG. 5 Plan views showing a production method for a TFT section of Embodiment 1.

FIG. 6 Cross-sectional views showing a production method for a TFT section of Embodiment 1.

FIG. 7 Plan views showing a production method for a reflection section of Embodiment 1.

FIG. 8 Cross-sectional views showing a production method for a reflection section of Embodiment 1.

FIG. 9 Cross-sectional views showing a production method for the semiconductor layer of Embodiment 1.

FIG. 10 Cross-sectional views showing variants of the reflection section of Embodiment 1, where (a) shows a reflection section according to a first variant, (b) shows a reflection section according to a second variant, and (c) shows a reflection section according to a third variant.

FIG. 11 A cross-sectional view showing a liquid crystal display device of Embodiment 2.

FIG. 12 A cross-sectional view showing an active matrix substrate of a conventional reflection-type LCD.

FIG. 13 A diagram showing a relationship between a tilt of a reflection surface and reflected light in a liquid crystal display device, where (a) shows a relationship between an incident angle α and an outgoing angle β when light enters a medium b having a refractive index Nb from a medium a having a refractive index Na, and (b) is a diagram showing a relationship between incident light and reflected light as well as the angle of the display surface of the LCD.

### DESCRIPTION OF THE REFERENCE NUMERALS

10 liquid crystal display device
12 TFT substrate
14 counter substrate
16 liquid crystal
18 liquid crystal layer
22 transparent substrate
26 interlayer insulating layer
28 pixel electrode
30, 30A, 30B, 30C reflection section
32 TFT section
34 counter electrode
36 CF layer
38 transparent substrate
40 display surface
42 reflection region
44 TFT region
46 transmission region
48 recess
50 pixel
52 source line
54 gate line
56 Cs line
58 contact hole
61, 61B, 61C gate insulating layer
62, 62A, 62B, 62C semiconductor layer
63 reflective layer
65, 65B, 65C aperture
67, 68 recess
75, 85 upper slope
76, 86 flat portion
77, 87 lower slope
78 first region
79 second region
88 bottom face
90 resist
100 active matrix substrate
101 insulative substrate
102 gate layer
104 gate insulating layer
106 semiconductor layer
108 metal layer
110 reflective layer
112 reflection surface

### BEST MODE FOR CARRYING OUT THE INVENTION

### Embodiment 1

Hereinafter, with reference to the drawings, a first embodiment of the liquid crystal display device according to the present invention will be described.

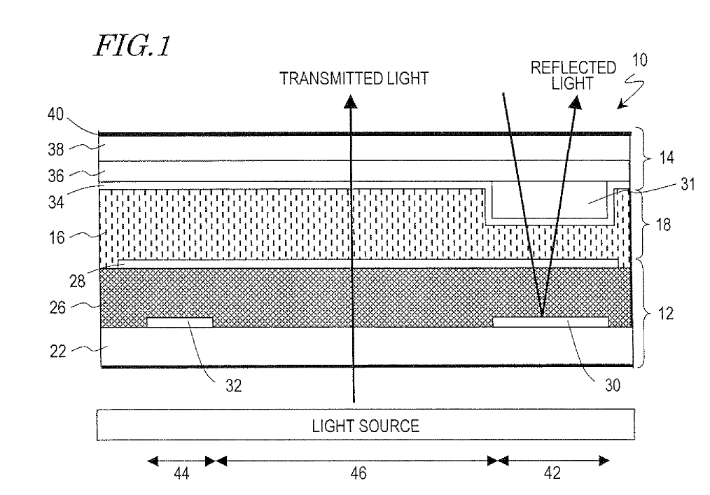

FIG. 1 schematically shows a cross-sectional shape of a liquid crystal display device 10 of the present embodiment. The liquid crystal display device 10 is a transflective-type liquid crystal display device by an active matrix method. As shown in FIG. 1, the liquid crystal display device 10 includes a TFT (Thin Film Transistor) substrate 12, a counter substrate 14, and a liquid crystal layer 18 containing liquid crystal 16 which is sealed between the TFT substrate 12 and the counter substrate 14.

The TFT substrate 12 comprises a transparent substrate 22, an interlayer insulating layer 26, and a pixel electrode 28, and includes reflection sections 30 and TFT sections 32. Gate lines (scanning lines), source lines (signal lines), and Cs lines (storage capacitor electrode lines) and the like are formed on the TFT substrate 12, which will be described later.

The counter substrate 14 is a color filter substrate (CF substrate), for example, including a counter electrode 34, a color filter layer (CF layer) 36, and a transparent substrate 38. The upper face of the transparent substrate 38 serves as a display surface 40 of the liquid crystal display device. Note that although the TFT substrate 12 and the counter substrate 14 each have an alignment film and a polarizer, they are omitted from the figure.

In the liquid crystal display device 10, a region where a reflection section 30 is formed is referred to as a reflection region 42, whereas a region where a TFT section 32 is formed is referred to as a TFT region 44. In a reflection region 42, light entering from the display surface 40 is reflected by the reflection section 30, and travels through the liquid crystal layer 18 and the counter substrate 14 so as to go out from the display surface 40. The liquid crystal display device 10 further has transmission regions 46 which are formed in regions other than the reflection regions 42 and the TFT regions 44. In the transmission regions 46, light which is emitted from a light source in the display device 10 travels through the TFT substrate 12, the liquid crystal layer 18, and the counter substrate 14 so as to go out from the display surface 40.

Note that, as shown in FIG. 1, by providing a layer 31 which is made of a transmissive resin or the like at the counter substrate 14 side above each reflection section 30, it is possible to reduce the thickness of the liquid crystal layer 18 in the reflection region 42 to a half of the thickness of the liquid crystal layer 18 in the transmission region 46. As a result, the optical path length (distance traveled by the light within the liquid crystal layer 18) can be made equal in the reflection region 42 and the transmission region 46. Although FIG. 1 illustrates the layer 31 as being formed between the counter electrode 34 and the CF layer 36, the layer 31 may be formed on the face of the counter electrode 34 facing the liquid crystal layer 18.

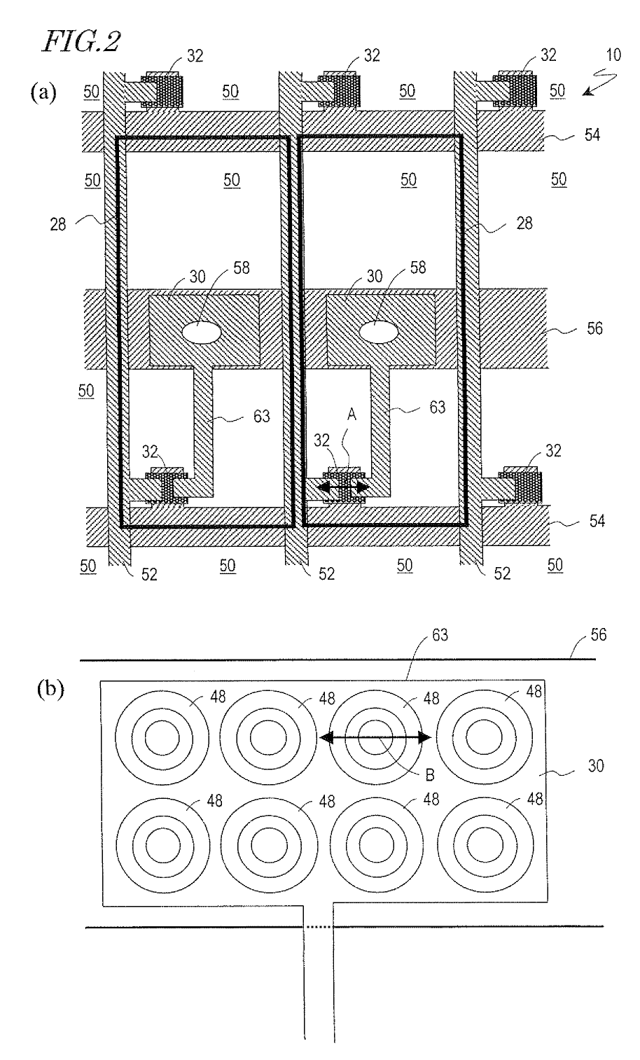

FIG. 2 is a plan view more specifically showing the construction of the pixel regions and reflection sections 30 of the liquid crystal display device 10.

FIG. 2(a) is a diagram showing a portion of the pixel regions of the liquid crystal display device 10 as seen from above the display surface 40. As shown in the figure, a plurality of pixels 50 (portions indicated by rectangles in thick lines) are provided in a matrix shape on the liquid crystal display device 10. The aforementioned reflection section 30 and TFT section 32 are formed in each pixel 50, with a TFT being formed in the TFT section 32.

In the border of the pixel 50, source lines 52 extend along the column direction (the top-bottom direction in the figure), and gate lines (gate metal layers) 54 extend along the row direction (the right-light direction in the figure). In the central portion of the pixel 50, a Cs line (Cs metal layer) 56 extends along the row direction. In the interlayer insulating layer 26 of the reflection section 30, a contact hole 58 for connecting the pixel electrode 28 and the drain electrode of the TFT is formed.

FIG. 2(b) is a plan view schematically showing the construction of the reflection section 30 above the Cs line 56. The contact hole 58 shown in FIG. 2(a) is omitted from this figure. As shown in the figure, a plurality of circular recesses (tapered portions, or recesses with level differences) 48 are formed in the reflection section 30. Note that, although eight recesses 48 are shown herein for easy understanding of the construction, the number of recesses 48 is not limited to eight, but more recesses 48 may be formed.

Note that, as will be described later, a reflective layer 63 is formed in an upper portion of the reflection section 30, such that the surface of the recesses 48 is formed as a face of the reflective layer 63. The reflective layer 63 is connected to the drain electrode of the TFT in the TFT section 32. Each recess 48 may be formed as a protrusion having a level difference.

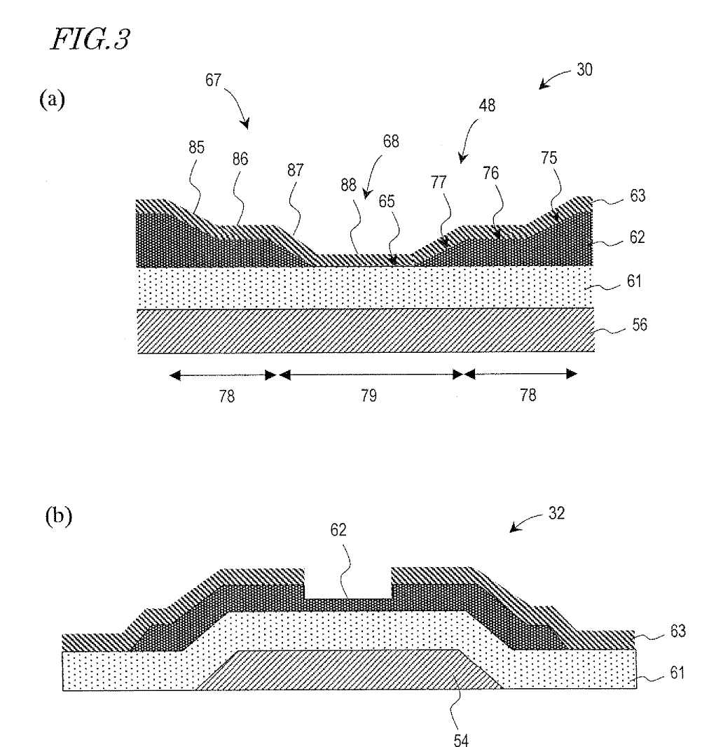

Next, with reference to FIG. 3, the construction of the reflection section 30 and the TFT section 32 will be described more specifically.

FIG. 3(a) shows a cross section of a recess 48 in the reflection section 30 (a cross section of a portion shown by arrow B in FIG. 2(b)). As shown in the figure, the Cs metal layer (metal layer) 56, the gate insulating layer 61, the semiconductor layer 62, and the reflective layer 63 are stacked in the reflection section 30. The semiconductor layer 62 is constructed from an intrinsic amorphous silicon layer (Si(i) layer) and an n+ amorphous silicon layer (Si(n+) layer) which is doped with phosphorus.

As shown in the figure, level differences are formed in the semiconductor layer 62 underlying the recess 48, and an upper slope 75, a flat portion 76, and a lower slope 77 are formed on the surface of the semiconductor layer 62. The flat portion 76 is formed so as to be generally parallel to the surface of the Cs line 56 or to the display surface 40 shown in WIG. 1. Moreover, the semiconductor layer 62 has an aperture 65 under the central portion of the recess 48.

On the surface of the reflective layer 63, a recess 67 (first recess) and a recess 68 (second recess) are formed in accordance with the level differences or cross-sectional shape of the semiconductor layer 62. The recess 68 is located inside the recess 67. When seen perpendicularly from the plane of the transparent substrate 22 (or the display surface 40), the recess 67 and the recess 68 are in the shape of concentric circles. Note that the shapes of the recess 67 and the recess 68 are not limited to concentric circles, but may be formed in various shapes, as will be described later.

The recess 67 and the recess 68 are formed as the reflective layer 63 becomes dented because the reflective layer 63 is formed over the upper slope 75, the flat portion 76, the lower slope 77, and the aperture 65 of the semiconductor layer 62. Therefore, on the surface of the reflective layer 63 inside the recess 67, an upper slope 85, a flat portion 86, a lower slope 87, and a bottom face 88 are formed, corresponding respectively to the upper slope 75, the flat portion 76, the lower slope 77, and the aperture 65 of the semiconductor layer 62.

In the present specification, the region where the upper slope 85 and the flat portion 86 are formed (the region corresponding to the recess 67) is referred to as a first region 78, whereas the region where the lower slope 87 and the bottom face 88 are formed (the region corresponding to the recess 68) is referred to as a second region 79. Under the flat portion 86, the semiconductor layer 62 has a constant thickness. The thickness of the gate insulating layer 61 is constant throughout the reflection section 30.

In the present embodiment, the semiconductor layer 62 in the first region 78 is formed so as to be thicker than the semiconductor layer 62 in the second region 79 (the semiconductor layer 62 is regarded as having zero thickness in the aperture 65). Moreover, in terms of a total thickness of the thickness of the semiconductor layer 62 and the thickness of the gate insulating layer 61, the thickness in the first region is greater than the thickness in the second region.

Although the recess 67 and the recess 68 as shown in FIG. 3(a) are formed in the reflective layer 63 in the reflection section 30, double protrusions with level differences may be formed in the process of forming the semiconductor layer 62, instead of recesses, and double protrusions with level differences may be correspondingly formed on the surface of the reflective layer 63.

FIG. 3(b) is a cross-sectional view showing the construction of the gate metal layer (metal layer) 54, the gate insulating layer 61, the semiconductor layer 62, and the reflective layer 63 in the TFT section 32. The gate metal layer 54 in the TFT section 32 is formed concurrently with and from the same member as the Cs metal layer 56 of the reflection section 30. Similarly, the gate insulating layer 61, the semiconductor layer 62, and the reflective layer 63 of the TFT section 32 are formed concurrently with and from the same members as the gate insulating layer 61, the semiconductor layer 62, and the reflective layer 63 of the reflection section 30, respectively.

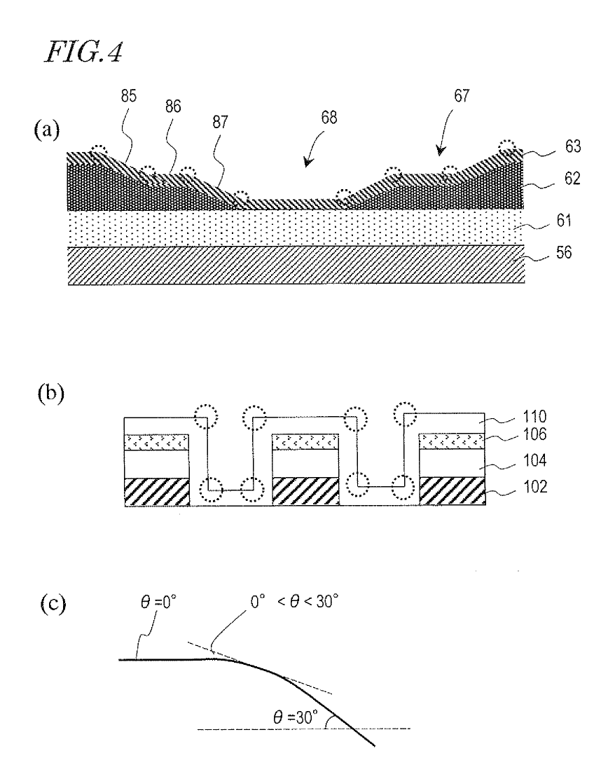

FIG. 4 is a diagram for comparing the structures of the reflection section 30 of the present embodiment and the reflection section of the conventional liquid crystal display device shown in FIG. 12. FIG. 4(a) schematically shows a cross-sectional structure of the reflection section 30 of the present embodiment, whereas FIG. 4(b) shows a cross-sectional structure of the reflection section of the conventional liquid crystal display device. As shown in these figures, on the surface of the reflective layer 63 of the present embodiment, as seen in its cross-sectional shape, eight corner portions (portions indicated by dotted lines in the figure) are formed in each of the recess 67 and the recess 68. On the other hand, in the conventional liquid crystal display device, only four corner portions are formed in one recess.

In each corner portion of the reflective layer, as shown in FIG. 4(c), a face having an angle greater than 20 degrees (in this figure, exemplified as 30 degrees) with respect to the substrate is continuously formed from a plane which is parallel to the substrate. Therefore, by forming more recesses in the reflection section, more effective reflection surfaces (faces having an angle of 20 degrees or less with respect to the substrate) can be formed at the surface of the reflective layer 63.

As shown in comparison in FIGS. 4(a) and (b), double recesses with level differences are formed in the reflection section 30 of the present embodiment, so that more corner portions are formed than in the conventional reflection section. Therefore, the surface of the reflective layer 63 has more effective reflection surfaces. Moreover, since the recess 67 and the recess 68 are formed in accordance with the shapes into which the semiconductor layer 62 is shaped, it is possible to easily adjust the shapes, depths, and the slope tilting angles of the recesses.

The tilting angles of the upper slope 85 and the lower slope 87 of the reflective layer 63 may be formed to be 20 degrees or less each, whereby the area of the effective reflection surfaces can be further increased. Moreover, an average tilting angle of a face that includes the upper slope 85, the flat portion 86, and the lower slope 87 may be formed to be 20 degrees or less, whereby also the area of the effective reflection surfaces can be increased.

Moreover, bottoms 88 of the reflective layer 63 are formed on the gate insulating layer 61. On the other hand, in the conventional liquid crystal display device, the reflective layer 110 on the bottom faces of the recesses is formed on the substrate, and neither a gate layer 102 nor a gate insulating layer 104 nor a semiconductor layer 106 is formed between the reflective layer 110 and the substrate in the recesses. Therefore, the bottoms 88 of the reflective layer 63 of the present embodiment are formed to be shallower than the bottom faces of the recesses of the conventional liquid crystal display device.

In the conventional liquid crystal display device, the recesses are formed in portions where the gate layer 102, the gate insulating layer 104, and the semiconductor layer 106 have been removed, so that the bottom faces of the recesses are formed at deep positions. Therefore, the inner surface of each recess has a large tilting angle, thus making it difficult to form within the recess a large number of effective reflection surfaces having a tilt of 20 degrees or less. Moreover, these recesses are formed by forming the gate layer 102, the gate insulating layer 104, and the semiconductor layer 106, and then removing these layers altogether. Therefore, the shapes of the Inner surfaces of the recesses or the tilting angles of the slopes cannot be controlled, thus making it difficult to increase the effective reflection surfaces.

In the display device of the present embodiment, double recesses are formed on the surface of the reflective layer 63 in accordance with the shape of the semiconductor layer 62. Therefore, when the semiconductor layer 62 is stacked, its shape (including the shapes and angles of the slopes, the shapes, sizes, and positions of the apertures, etc.) can be adjusted. As a result, by controlling the tilt of the reflection surface of the reflective layer 63, a large number of effective reflection surfaces having a tilt of 20 degrees less can be formed, and more light can be reflected toward the display surface.

Next, a production method for the TFT substrate 12 according to the present embodiment will be described.

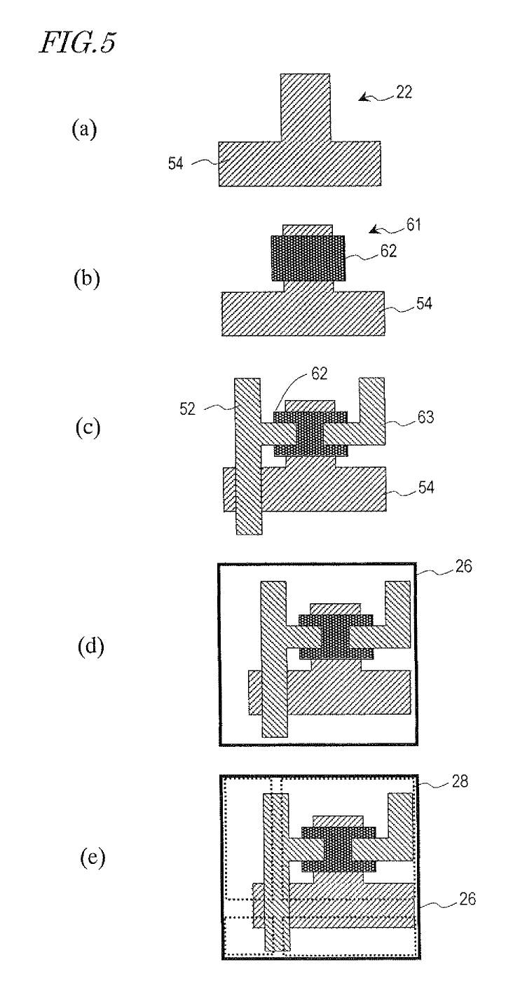

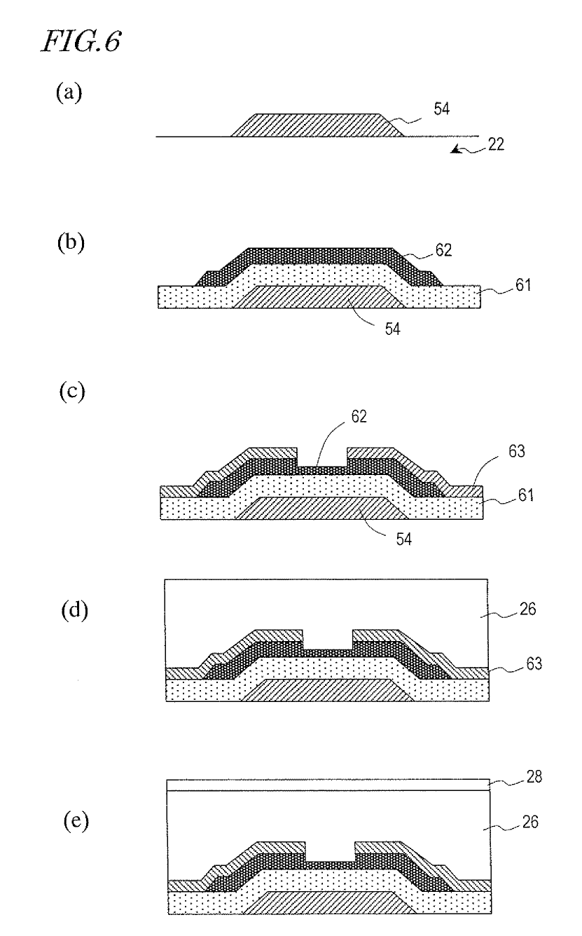

FIG. 5 is plan views showing a production method for the TFT substrate 12 in the TFT section 32. FIG. 6 is cross-sectional views showing a production method for the TFT substrate 12 in the TFT section 32, showing a cross section of a portion shown by arrow A in FIG. 2(a).

As shown in FIG. 5(a) and FIG. 6(a), first, by a method such as sputtering, a thin metal film of Al (aluminum) is formed on the transparent substrate 22 having been cleaned. Note that, other than Al, this thin metal film may be formed by using Ti (titanium), Cr (chromium), Mo (molybdenum), Ta (tantalum), W (tungsten), or an alloy thereof, etc., or formed from a multilayer body of a layer of any such material and a nitride film.

Thereafter, a resist film is formed on the thin metal film, and after forming a resist pattern through an exposure and development step, a dry or wet etching is performed to form the gate metal layer (metal layer) 54. The gate metal layer 54 has a thickness of 50 to 1000 nm, for example.

Thus, the gate metal layer 54 which is formed by photolithography technique serves as a gate electrode of the TFT. Note that, in this step, the gate lines (gate metal layer) 54 shown in FIG. 2(a) and the Cs metal layer 56 of the reflection section 30 shown in FIG. 3(a) are also formed from the same metal concurrently.

Next, as shown in FIG. 5(b) and FIG. 6(b), by using P-CVD technique and a gaseous mixture of SiH₄, NH₃, and N₂, the gate insulating layer 61 composed of SiN (silicon nitride) is formed across the entire substrate surface. The gate insulating layer 61 may also be composed of SiO₂ (silicon oxide), Ta₂O₅ (tantalum oxide), Al₂O₃ (aluminum oxide), or the like. The thickness of the gate insulating layer 61 is e.g. 100 to 600 nm. In this step, the gate insulating layer 61 of the reflection section 30 shown in FIG. 3(a) is also formed concurrently.

Next, on the gate insulating layer 61, an intrinsic amorphous silicon (a-Si) film (Si(i) film) and an n⁺a-Si film obtained by doping amorphous silicon with phosphorus (P) (Si(n+) film). The thickness of the a-Si film is e.g. 30 to 300 nm, and the thickness of the n⁺a-Si film is e.g. 20 to 100 nm. Thereafter, these films are shaped by photolithography technique, whereby the semiconductor layer 62 is formed. In this step, the semiconductor layer 62 of the reflection section 30 shown in FIG. 3(a) is also formed concurrently.

Next, as shown in FIG. 5(c) and FIG. 6(c), a thin metal film of Al or the like is formed across the entire substrate surface by sputtering technique or the like, and a photolithography technique is performed to form the reflective layer 63. For the thin metal film, the materials which are mentioned above as materials for the gate metal layer 54 may be used. The thickness of the reflective layer 63 is e.g. 30 to 1000 nm.

In the TFT section 32, the reflective layer 63 forms a source electrode and a drain electrode of the TFT. At this time, the source line 52 in FIG. 2(a) is also formed as a portion of the reflective layer 63, and the reflective layer 63 of the reflection section 30 shown in FIG. 3(a) is also formed concurrently.

Next, as shown in FIG. 5(d) and FIG. 6(d), a photosensitive acrylic resin is applied by spin-coating, whereby the interlayer insulating layer (interlayer resin layer) 26 is formed. The thickness of the interlayer insulating layer 26 is e.g. 0.3 to 5 μm. Although a thin film such as SiNₓ or SiO₂ may be formed by P-CVD technique as a protection film between the reflective layer 63 and the interlayer insulating layer 26, such is omitted from the figure. The thickness of the protection film is e.g. 50 to 1000 nm. The interlayer insulating layer 26 and the protection film are formed not only on the TFT section 32, but also on the entire upper surface of the transparent substrate 22 including the reflection section 30.

Next, as shown in FIG. 5(e) and FIG. 6(e), on the interlayer insulating layer 26, a transparent electrode film such as ITO or IZO is formed by sputtering technique or the like. This transparent electrode film is pattern shaped by photolithography technique, whereby the pixel electrode 28 is formed. The pixel electrode 28 is formed not only on the TFT section 32 but also on the entire upper surface of the pixel including the reflection section 30.

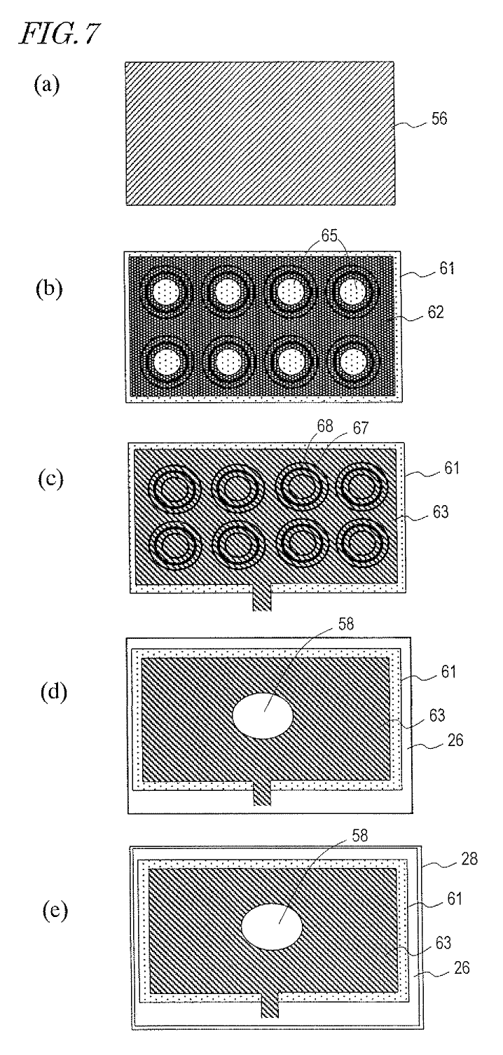

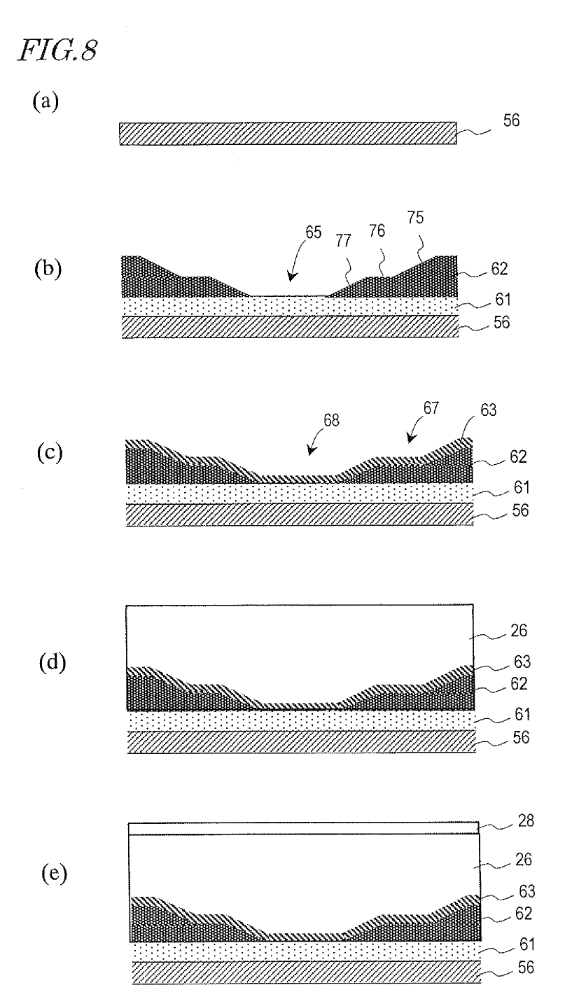

Next, by using FIG. 7 and FIG. 8, a production method for the TFT substrate 12 in the reflection section 30 will be described.

FIG. 7 is a plan view showing a production method for the TFT substrate 12 in the reflection section 30. FIG. 8 is cross-sectional views showing a production method for the TFT substrate 12 in the reflection section 30, showing a cross section of a portion shown by arrow C in FIG. 2(b). The steps shown at (a) to (e) in FIG. 7 and FIG. 8 correspond to the steps of (a) to (e) in FIG. 5 and FIG. 6, respectively.

As shown in FIG. 7(a) and FIG. 8(a), the Cs metal layer 56 in the reflection section 30 is formed, by a similar method, concurrently with and from the same metal as the gate metal layer 54 in the TFT section 32.

Next, as shown in FIG. 7(b) and FIG. 8(b), the gate insulating layer 61 is formed above the Cs metal layer 56 by a method similar to that for the TFT section 32, and thereafter the semiconductor layer 62 is formed. Thereafter, a plurality of recesses each having a level difference and having an aperture 65 in the center are formed in the semiconductor layer 62; the production process for the recesses will be specifically described late. The thickness of the semiconductor layer 62 is e.g. 50 to 400 nm.

Next, as shown in FIG. 7(c) and FIG. 8(c), the reflective layer 63 is formed above the semiconductor layer 62 by a method similar to that for the TFT section 32. At this time, in the apertures 65 of the semiconductor layer 62, the reflective layer 63 is formed so as to be in contact with the gate insulating layer 61. In accordance with the shape of the semiconductor layer 62, recesses 67 and recesses 68 are formed on the surface of the reflective layer 63.

Next, as shown in FIG. 7(d) and FIG. 8(d), the interlayer insulating layer 26 is formed from photosensitive acrylic resin. Thereafter, through a development process using an exposure apparatus, a contact hole 58 is formed near the center of the reflection section 30.

Next, as shown in FIG. 7(e) and FIG. 8(e), the pixel electrode 28 is formed. In the reflection section 30, the pixel electrode 28 is formed above the interlayer insulating layer 26 and the contact hole 58, such that the metal member of the pixel electrode 28 is in contact with the reflective layer 63 via the contact hole 58. As a result, the drain electrode of the TFT in the TFT section 32 is electrically connected with the pixel electrode 28 via the contact hole 58.

Preferably, as many recesses 67 and recesses 68 as possible are formed in the reflection section 30. Therefore, it is preferable that as many upper slopes 75, flat portions 76, lower slopes 77, and apertures 65 of the semiconductor layer 62 as possible are formed on the reflection surface, within the technological limits of the masks, photoexposure, etching and the like in the production steps. The preferable size of the aperture 65 in the semiconductor layer 62 is of 2 to 10 μm in diameter. The preferable sizes of the outer peripheries of each recess 67 and each recess 68 are, respectively, 3 to 15 μm and 2 to 10 μm in diameter.

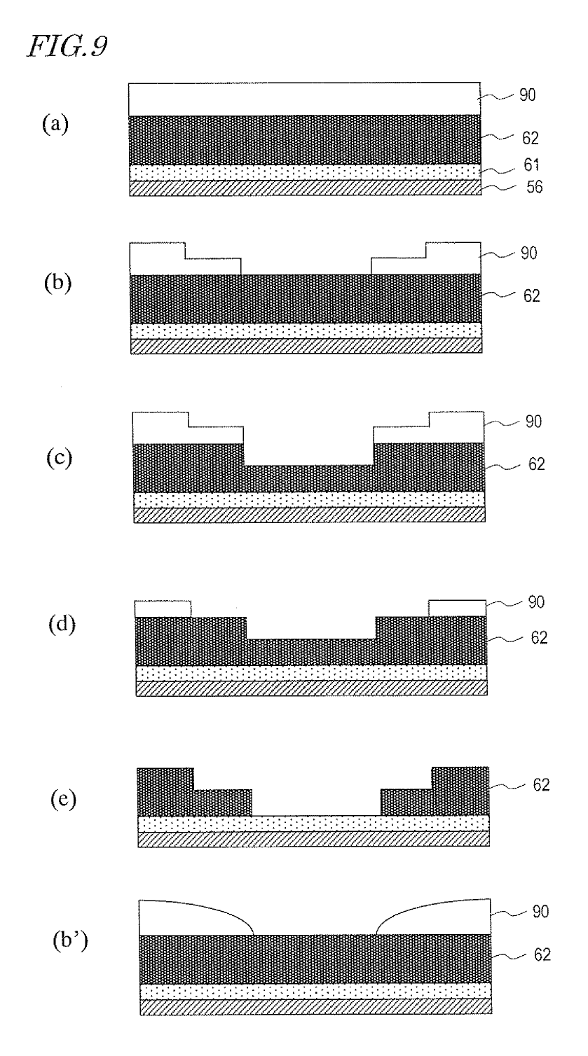

Next, with reference to FIG. 9, a method for forming the aforementioned recesses of the semiconductor layer 62 will be described more specifically. FIG. 9 is cross-sectional views for describing a method for forming the recesses of the semiconductor layer 62.

First, as shown in FIG. 9(a), on the semiconductor layer 62 stacked on the gate insulating layer 61, which has no recesses formed therein yet, a resist 90 that is e.g. a positive-type photosensitive film is applied to a thickness of e.g. 1600 to 2000 nm.

Next, as shown in FIG. 9(b), recesses are formed in the resist 90 by half tone exposure. As the mask for exposure, a mask having a pattern formed by lattice-like slits is used, for example. The slits are formed so that their line widths locally differ or the intervals between adjoining slits locally differ. With such slits, the light transmittance of the mask can be differentiated in accordance with a desired pattern. Herein, a pattern for leaving a resist 90 having level differences as shown in the figures is formed in the mask.

The light transmittance of the mask is: e.g. 90% or more in the portion where the resist 90 should be completely removed (corresponding to the central portion in FIG. 9(b)); e.g. 3% or less in the portion where the resist should be almost entirely left (corresponding to both ends in FIG. 9(b)); and e.g. 20 to 60% in the portion therebetween (the portion where some resist should be left). Note that such transmittance may be varied gradually or in a stepwise manner in accordance with the mask pattern. When the transmittance is gradually varied, a resist pattern will be formed which has gently-changing slopes with no corner portions, as will be shown later in FIG. 9(b′).

When performing half tone exposure, other than the aforementioned method, a mask which is patterned by varying the thickness of a translucent film may be used. Alternatively, a mask pattern can be formed from a plurality of translucent films having respectively different transmittances. As the translucent films, chromium (Cr), magnesium oxide (MgO), molybdenum silicide (MoSi), amorphous silicon (a-Si), or the like may be used.

When the resist 90 is irradiated with light through such a mask, the polymer of the resist 90 is decomposed by the light. In the resist 90, more polymer is decomposed and removed via cleaning in the portions irradiated with more light, whereas the polymer is hardly decomposed and left with the thickness from the initial state in the portions where light irradiation is blocked by the mask. As a result, the shape of the mask pattern is developed on the resist 90. Note that the Irradiation time must be appropriately set because, if the light irradiation time is too long, all polymer in the resist 90 may be decomposed.

Next, an etching process (hereinafter referred to as a first etching process) is performed, and as shown in FIG. 9(c), an upper portion of the exposed portion of the semiconductor layer 62, which is not covered by the resist 90, is removed. Even in the case where the resist 90 of a shape as shown in FIG. 9(b′) is formed, the present etching process and a process which is similar to the process described below with reference to FIGS. 9(d) to (e) are performed.

Next, an asking treatment is performed. Through the ashing treatment, any portion of the resist 90 having a thin film thickness is removed completely, whereas any portion having a thick film thickness is removed only in its upper portion. As a result, the resist 90 of a shape as shown in FIG. 9(d) is left.

Thereafter, an etching process is again performed (hereinafter referred to as a second etching process). Thus, in the semiconductor layer 62 not covered by the resist 90, any portion having a thin film thickness is completely removed, whereas any portion having a thick film thickness is removed only in its upper portion. As a result, a semiconductor layer 62 having recesses as shown in FIG. 9(e) is formed. The remaining resist 90 is removed after the etching process is ended. Note that slopes as shown in FIG. 8(b) will actually be formed in the recesses of the semiconductor layer 62. However, in order to facilitate the understanding of the recess forming method, these slopes are illustrated as faces that are perpendicular to the substrate in FIG. 9.

In the present embodiment, when forming recesses in the resist 90, a half tone exposure is performed by using a mask whose transmittance has local differences as described above. However, second to fourth exposure methods below can also be used for forming the recesses.

A second exposure method is a method which performs a so-called two-step exposure by using two masks having respectively different patterns, instead a mask. In this case, first, a first mask in which a pattern is formed with light shielding portions and transmitting portions is used to perform a patterning, and thereafter a second mask having a different pattern from that of the first mask is used to perform a patterning. With this method, too, the recesses as shown in FIG. 9(b) can be formed.

A third exposure method is a method which performs patterning by appropriately setting a mask thickness and a distance between a mask and a resist to utilize diffraction of irradiation light or change the direction of light irradiation. In this case, irradiation light is not completely blocked at the ends of the light shielding portions of the mask, but its irradiation intensity gradually decreases as going inside from the ends of the light shielding portions. As a result, a resist 90 having a gently changing film thickness as shown in FIG. 9(b′) is formed.

A fourth exposure method is a method which utilizes reflow of the resist 90. In this case, first, a resist 90 of a shape which is in accordance with the mask pattern is left with a certain thickness upon the semiconductor layer 62. Thereafter, the resist 90 is allowed to reflow, thus expanding the area of the resist 90. As a result, a resist 90 having gradually differing thicknesses as shown in FIG. 9(b′) is formed.

In the above-described production steps for the semiconductor layer 62, recesses which are in the form of concentric circles with level differences are formed on the semiconductor layer 62. However, protrusions which are in the form of concentric circles with level differences may be used by using a mask pattern in which the transmitting portions and the light shielding portions are inverted from the aforementioned mask pattern.

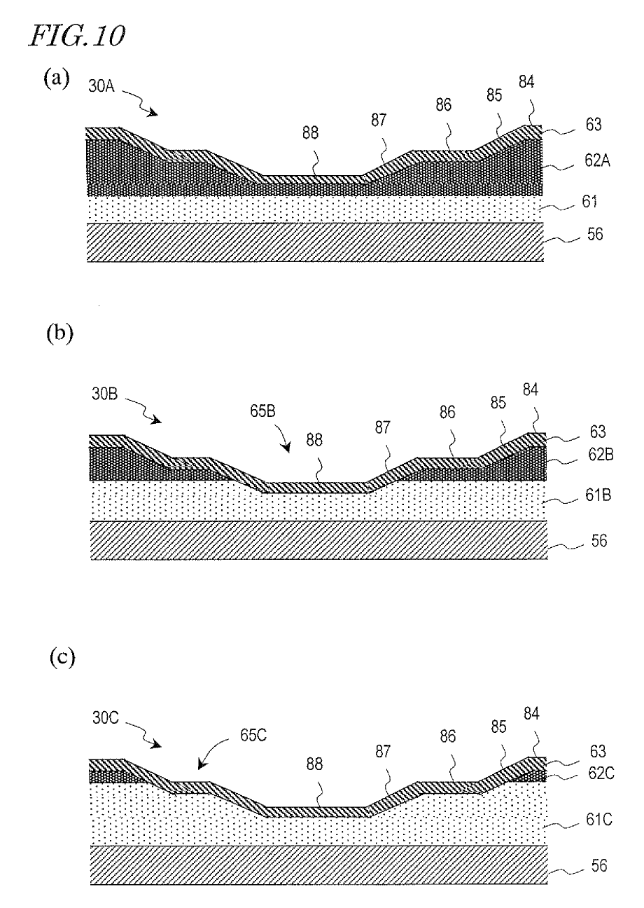

Next, with reference to FIG. 10, variants of the reflection section 30 of the liquid crystal display device 10 of the present embodiment will be described. In FIG. 10, (a) to (c) are cross-sectional views respectively showing first to third variants of the reflection section 30.

A first variant reflection section 30A includes a semiconductor layer 62A of a shape shown in FIG. 10(a). On the surface of the reflective layer 63, a first recess and a second recess located inside it are formed in accordance with the level differences or cross-sectional shape of the semiconductor layer 62A. An aperture 65 as shown in FIG. 3(a) is not formed in the semiconductor layer 62A, so that the semiconductor member is left also in the portion which would correspond to the aperture 65. Therefore, the bottom face 88 of the reflective layer 63 is formed on the semiconductor layer 62A.

The semiconductor layer 62A of such a shape can be obtained by reducing the etching time in one or both of the first etching step described using FIG. 9(c) and the second etching step described using FIG. 9(e), for example. In this case, the thickness of the semiconductor layer 62A is e.g. 40 to 350 nm.

A second variant reflection section 30B includes a semiconductor layer 62B and a gate insulating layer 61B of shapes shown in FIG. 10(b). On the surface of the reflective layer 63, a first recess and a second recess located inside it are formed in accordance with the level differences or cross-sectional shape of the semiconductor layer 62B and the insulating layer 61B. Although an aperture 65B is formed in the semiconductor layer 62B according to this variant, a portion of the gate insulating layer 61B under the aperture 65B is also removed. Therefore, the bottom face 88 of the reflective layer 63 is formed in the gate insulating layer 61B. As for the lower slope 87 of the reflective layer 63, an upper portion thereof is formed on the semiconductor layer 62B, and a lower portion thereof is formed on the gate insulating layer 61B.

The semiconductor layer 62B and the gate insulating layer 61B of such shapes are obtained by prolonging the etching time in one or both of the first etching step and the second etching step, thus removing not only the semiconductor layer 62B but also a portion of the gate insulating layer 61B in the second etching step, for example. In this case, the thickness of the gate insulating layer 61B is e.g. 50 to 550 nm, and the thickness of the semiconductor layer 62B is e.g. 40 to 350 nm.

A third variant reflection section 30C includes a semiconductor layer 62C and a gate insulating layer 61C of shapes shown in FIG. 10(c). On the surface of the reflective layer 63, a first recess and a second recess located inside it are formed in accordance with the level differences or cross-sectional shape of the semiconductor layer 62C and the insulating layer 61C. An aperture 65C is formed in the semiconductor layer 62C, and a portion of the gate insulating layer 61C under the aperture 65C is also removed. The bottom face 88 of the reflective layer 63 is formed in the gate insulating layer 61C, and the lower slope 87 of the reflective layer 63 is entirely formed on the gate insulating layer 61C. As for the upper slope 85 of the reflective layer 63, an upper portion thereof is formed on the semiconductor layer 62C, and a lower portion thereof is formed on the gate insulating Layer 61C.

The semiconductor layer 62C and the gate insulating layer 61C of such shapes are obtained by prolonging the etching time in the second etching step, thus entirely removing in the second etching step any portion of the semiconductor layer 62C that is not covered by the resist 90, for example. In this case, the thickness of the gate insulating layer 61C is e.g. 50 to 550 nm, and the thickness of the semiconductor layer 62C is e.g. 40 to 350 nm.

In any of the above-described first to third variant reflection sections 30A, 30B, and 30C, the total thickness of the semiconductor layer 62 and the gate insulating layer 61 is thicker under the recess 67 (first region) than in the recess 68 (second region). Even when employing such variants, it is possible to form a reflective layer of a shape similar to the reflective layer 63 shown in FIG. 3(a). Therefore, also according to these variants, the effective reflection surfaces can be increased so as to allow more light to be reflected toward the display surface.

### Embodiment 2

Hereinafter, a second embodiment of the liquid crystal display device according to the present invention will be described with reference to the drawings. Note that the same reference numerals are attached to those elements which are identical to the constituent elements in Embodiment 1, and the descriptions thereof are omitted.

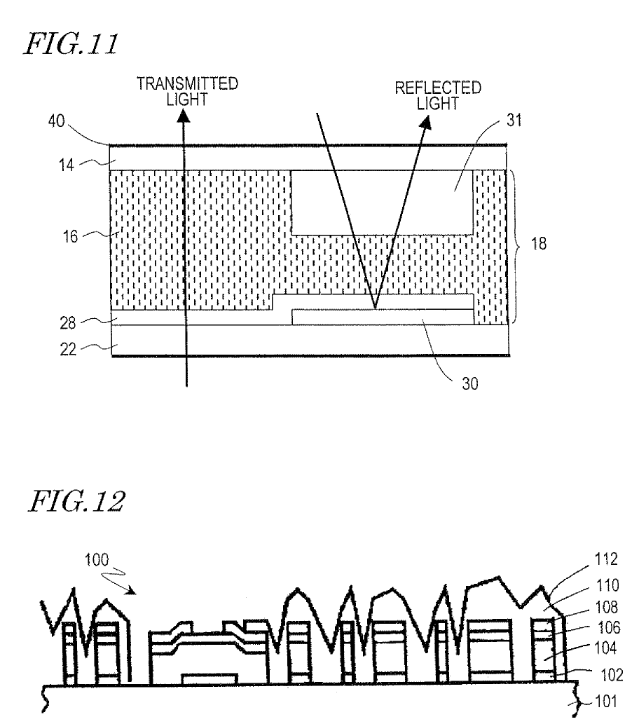

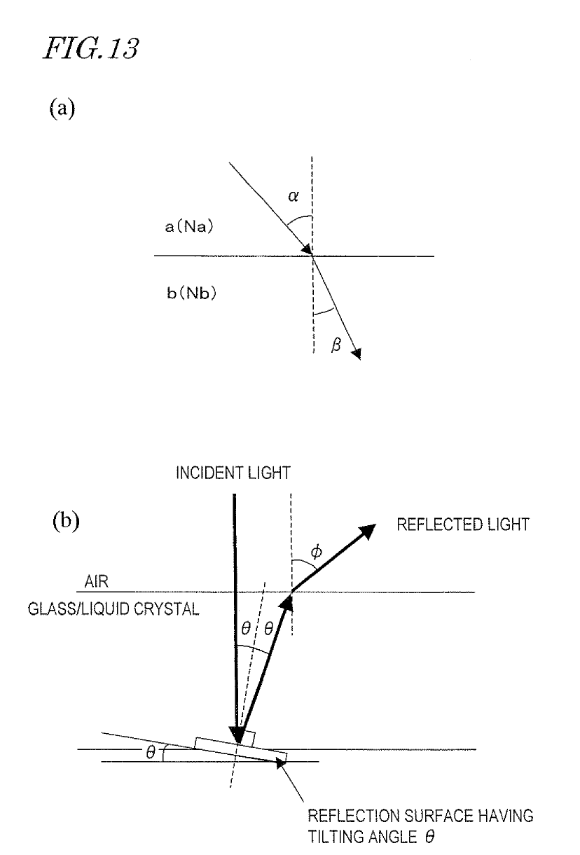

FIG. 11 is a diagram schematically showing a cross-sectional shape of the liquid crystal display device of the present embodiment. This liquid crystal display device is based on the display device of Embodiment 1 from which the interlayer insulating layer 26 is excluded, and is identical to the liquid crystal display device of Embodiment 1 except for the points discussed below. Note that, in FIG. 11, the detailed structure of the counter substrate 14 and the TFT section 32 are omitted from illustration.

As shown in the figure, in the liquid crystal display device of the present embodiment, no interlayer insulating layer is formed, and therefore the pixel electrode 28 is formed upon the reflective layer 63 in the reflection section 30 and in the TFT section 32, via an insulating film not shown. The structure and production method for the reflection section 30 and the TFT section 32 are the same as in the liquid crystal display device of Embodiment 1 except that the interlayer insulating layer 26 is eliminated. The pixel layout and wiring structure in the liquid crystal display device are also similar to what is shown in FIG. 2(a).

Also with this construction, as in Embodiment 1, the effective reflection surfaces of the reflective layer 63 are expanded in area, so that more light can be reflected toward the display surface 40.

In Embodiment 1 and Embodiment 2 above, recess 67 and recess 68 formed on the surface of the reflective layer 63 of the reflection section 30 are illustrated as being in the form of concentric circles when seen perpendicularly from the substrate. However, in the patterning step for the semiconductor layer 62 illustrated by using FIG. 9, different mask patterns may be used in order to change the shapes of the recesses formed in the semiconductor layer 62, thus positioning the recess 67 and the recess 68 so that their centers are different. Moreover, the perimeters of the recess 67 and the recess 68 may overlap in a portion thereof. In these cases, too, a large number of recesses having level differences are formed on the surface of the reflective layer 63, whereby the effective reflection surfaces can be expanded.

In the above-described embodiments, each recess 67 and each recess 68 are formed to be circles. However, one or both of them may be formed into various shapes, e.g., ellipses, triangles, polygons such as quadrangles, recesses with sawtoothed edges, or combinations thereof. Moreover, the shape of one recess and the shape of the other recess may be different, and the two may be formed so that their perimeters overlap in a portion thereof. In these cases, too, a large number of recesses with level differences, which may be circles, ellipses, polygons, or overlapping shapes thereof, are formed on the surface of the reflective layer 63, whereby the effective reflection surfaces can be expanded.

The above-described embodiments illustrate cases where two regions are formed in the reflection section 30 which differ in a total thickness of the thickness of the semiconductor layer and the thickness of the gate insulating layer (the first region 78 and the second region 79). However, by changing the mask pattern, for example, three or more regions may be formed in the reflection section 30 which differ in a total thickness of the thickness of the semiconductor layer and the thickness of the gate insulating layer, in the step of forming the recesses in semiconductor layer and the gate insulating layer. In this case, on the surface of the reflective layer 63, in accordance with the shapes of the semiconductor layer and the gate insulating layer, triple or more overlapping recesses are formed. Specifically, one or more recesses having different depths from those of the recess 67 and the recess 68 are formed outside the recess 67, inside the recess 68, or between the recess 67 and the recess 68. A liquid crystal display device incorporating a reflection section 30 having such a reflective layer 63 is also encompassed by the liquid crystal display device according to the present invention.

The liquid crystal display device according to the present invention encompasses display apparatuses, television sets, mobile phones, etc., in which a liquid crystal panel is utilized. Moreover, although the present embodiments illustrate transflective-type liquid crystal display devices as examples, a reflection-type liquid crystal display device or the like having a similar configuration to the aforementioned reflection section would also be encompassed as one configuration of the present invention.

Since the liquid crystal display device according to the present invention is formed by the above-described production methods, It can be produced with the same materials and steps as those for a transmission-type liquid crystal display device. Therefore, at low cost, a liquid crystal display device having a reflection efficiency can be provided.

### INDUSTRIAL APPLICABILITY

According to the present invention, transflective-type and reflection-type liquid crystal display devices having a high image quality can be provided at low cost. Liquid crystal display devices according to the present invention can be suitably used for transflective-type and reflection-type liquid crystal display devices which perform display by utilizing reflected light, e.g., mobile phones, onboard display device such as car navigation systems, display devices of ATMs and vending machines, etc., portable display devices, laptop PCs, and the like.

1. A liquid crystal display device comprising a reflection region for reflecting incident light toward a display surface, wherein,
the reflection region includes an insulating layer, a semiconductor layer formed above the insulating layer, and a reflective layer formed above the semiconductor layer;
a first recess and a second recess which is located inside the first recess are formed on a surface of the reflective layer; and
the reflection region includes a first region and a second region which differ in a total thickness of a thickness of the insulating layer and a thickness of the semiconductor layer, and the first recess and the second recess are formed in accordance with a cross-sectional shape of at least one of the insulating layer and the semiconductor layer.

2. The liquid crystal display device of claim 1, wherein the first region includes a flat region where the total thickness of the thickness of the insulating layer and the thickness of the semiconductor layer is substantially constant.

3. The liquid crystal display device of claim 1, wherein the thickness of the semiconductor layer in the first region is thicker than the thickness of the semiconductor layer in the second region.

4. The liquid crystal display device of claim 1, wherein the thickness of the insulating layer in the first region is substantially equal to the thickness of the insulating layer in the second region.

5. The liquid crystal display device of claim 1, wherein the thickness of the insulating layer in the first region is thicker than the thickness of the insulating layer in the second region.

6. The liquid crystal display device of claim 1, wherein a first slope is formed in the first recess and a second slope is formed inside the second recess.

7. The liquid crystal display device of claim 6, wherein each of the first slope and the second slope has a face having a tilting angle of 20 degrees or less with respect to the display surface.

8. The liquid crystal display device of claim 6, wherein each of the first slope and the second slope has an average tilting angle of 20 degrees or less with respect to the display surface.

9. The liquid crystal display device of claims 6, wherein a flat surface which is substantially parallel to the display surface is formed between the first slope and the second slope, and the first slope, the flat surface, and the second slope have an average tilting angle of 20 degrees or less with respect to the display surface.

10. The liquid crystal display device of claim 1, wherein the first recess and the second recess are each formed in plurality in the reflection region.

11. A production method for a liquid crystal display device having a reflection region for reflecting incident light toward a display surface, comprising:
a step of forming an insulating layer;
a step of forming a semiconductor layer above the insulating layer;
a step of forming a first region and a second region which differ in a total thickness of the thickness of the insulating layer and the thickness of the semiconductor layer; and
a step of forming a reflective layer above the semiconductor layer, wherein,
in accordance with a cross-sectional shape of at least one of the insulating layer and the semiconductor layer, a first recess and a second recess which is located inside the first recess are formed on a surface of the reflective layer.

12. The production method of claim 11, wherein, in the first region, a flat region where the total thickness of the thickness of the insulating layer and the thickness of the semiconductor layer is substantially constant is formed.

13. The production method of claim 11, wherein the step of forming the first region and the second region comprises a step of forming two regions of respectively different thicknesses in the semiconductor layer in the reflection region.

14. The production method of claim 11, wherein the step of forming the first region and the second region comprises a step of forming two regions of respectively different thicknesses in the insulating layer in the reflection region.

15. The production method of claim 11, wherein the step of forming the first region and the second region comprises a step of forming an aperture in the semiconductor layer.

16. The production method of claim 11, wherein the step of forming the first region and the second region comprises a step of forming a first slope on the semiconductor layer in the first region and a step of forming a second slope on the semiconductor layer or the insulating layer in the second region.

17. The production method of claim 11, wherein the first region and the second region are formed by half tone exposure.

18. The production method of claim 11, wherein the first region and the second region are formed by two-step exposure.

19. The production method of claims 11, wherein,
the liquid crystal display device includes a semiconductor device;
a semiconductor section of the semiconductor device is formed in the step of forming the semiconductor layer; and
a source electrode and a drain electrode of the semiconductor device are formed in the step of forming the metal layer.
